(19) United States
(12) Patent Application Publication
(10) Pub. No.: US 2010/0282597 A1
(43) Pub. Date: Nov. 11, 2010

(54) METHOD FOR CONTROLLING PLASMA DENSITY DISTRIBUTION IN PLASMA CHAMBER

(76) Inventor: Young Kim, Cupertino, CA (US)

Correspondence Address: SUGHRUE MION, PLLC, 2100 PENNSYLVANIA AVENUE, N.W., SUITE 800, WASHINGTON, DC, 20037, US

(21) Appl. No.: 12/811,181

(22) PCT Filed: Dec. 30, 2008
(86) PCT No.: PCT/KR2008/007780

§ 371 Date: Jun. 29, 2010

(30) Foreign Application Priority Data
Dec. 31, 2007 (KR) 10-2007-0141335

(51) Int. Cl. H05H 1/24

(52) U.S. Cl. 204/164

(57) ABSTRACT

A method for controlling plasma density distribution in a plasma chamber in order to control a critical dimension (CD) and obtain uniformity of an etching rate. The plasma density distribution control method is used to fabricate a semiconductor device in the plasma chamber and comprises the steps of establishing an intended plasma density distribution in the plasma chamber and controlling a voltage distribution in the plasma chamber with relation to the established plasma density distribution.

### TECHNICAL FIELD

The present invention relates to a method for manufacturing a semiconductor, and more particularly to a method for controlling plasma density distribution in a plasma chamber in order to control a critical dimension (CD) and obtain uniformity of an etching rate.

### BACKGROUND ART

Techniques for manufacturing ultra-large scale integrated (ULSI) circuit elements have been remarkably improved over the past two decades. This remarkable development has been achieved due to semiconductor manufacturing equipments, which have been able to support processing techniques in the forefront of the technologies. A plasma reactor chamber or simply plasma chamber is one of the equipments used for manufacturing semiconductor devices typically in an etching process but is also being used in a depositing process and others as it gradually broadens its applications.

The plasma chamber for the semiconductor manufacturing internally forms plasma, which is used to perform the etching process, the depositing process, etc. Such plasma chambers are classified by the plasma sources of various types, such as electron cyclotron resonance (ECR) plasma sources, helicon-wave excited plasma (HWEP) sources, capacitively coupled plasma (CCP) sources, inductively coupled plasma (ICP) sources, etc.

Recently suggested is an adaptively coupled plasma (ACP) source, which has the advantages of the capacitively coupled plasma CCP and inductively coupled plasma ICP sources combined.

FIG. 1 is a schematic sectional view of a plasma chamber including a conventional ACP source, and FIG. 2 is a plan view of the ACP source shown in FIG. 1.

Referring to FIGS. 1 and 2, a plasma chamber 100 has a reacting space 104 in a predetermined size defined by an outer wall 102 of the plasma chamber and a dome 112. Plasma 110 is formed in an area of the reacting space 104 under a predetermined condition. Although the reacting space 104 is illustrated in the drawing to open at a lower part of the plasma chamber 100 for the sake of simplicity, the lower part of the plasma chamber 100 in practice is also isolated from the atmosphere so that the interior of the plasma chamber 100 maintains a vacuum. A wafer supporter (or an electrostatic chuck) 106 is arranged at the lower part of the plasma chamber 100. A semiconductor wafer 108 to be processed is safely seated on an upper surface of the wafer supporter 106. The wafer supporter 106 is connected with an RF bias power supply 116 positioned at the outside thereof. Although not shown in the drawings, a heater may be arranged within the wafer supporter 106. A plasma source 200 for forming plasma 110 is arranged at an outer surface of the dome 112. As shown in FIG. 2, the plasma source 200 may comprise a plurality of unit coils, such as four coils of first, second, third, and fourth unit coils 131, 132, 133, and 134, and a bushing 120. Specifically, the bushing 120 may be positioned at a center from which the first, second, third, and fourth unit coils 131, 132, 133, and 134 extend spiraling around the bushing 120.

Although the number of unit coils in the illustration is four, the number thereof can be more or less than four. At the center of the bushing 120 a supporting bar 140 is arranged protruding toward a direction perpendicular to the upper surface of the bushing 120. The supporting bar 140 may be connected to a terminal of the RF power supply 114. The other terminal of the RF power 114 may be grounded. Power from the RF power supply 114 is supplied to the first, second, third, and fourth unit coils 131, 132, 133, and 134 through the supporting bar 140 and the bushing 120. Such a conventional plasma source coil 200 has a circular structure where coils extend from the bushing 120 so as to wind around the bushing 120. According to such circular structure, the intensity of a magnetic field is obtained by Math FIG. (1) below.

$$\frac{\partial B}{\partial t} = - ∇ \times E \qquad [ Math Figure 1 ]$$

In Math FIG. (1), B is magnetic flux density, ∇ is a del operator, and E is the intensity of an electric field.

### DISCLOSURE

### Technical Problem

A magnetic field formed according to the above Maxwell's equation is applied to most plasma source coils having a circular structure where a magnetic declination is generated in a radial direction within the range extending from the center of the plasma source coil to the periphery thereof. This results in disadvantages of a difficult control of a critical dimension (CD) and low uniformity of the etching rate at the center and the periphery of the plasma source coil.

### Technical Solution

Therefore, the present disclosure has been made in view of the above-mentioned problems to provide a method for controlling plasma density distribution in a plasma chamber so as to obtain a critical dimension (CD) control and the etching rate uniformity. An aspect of the present disclosure provides a method for controlling plasma density distribution in a plasma chamber used to fabricate a semiconductor device comprising establishing an intended plasma density distribution in the plasma chamber and controlling a voltage distribution in the plasma chamber with relation to the established plasma density distribution.

In controlling the voltage distribution, an embodiment of the voltage distribution comprises a first value of a first voltage applied to a fabrication object at its central area in the plasma chamber and a second varying voltage applied to an edge of the central area as it starts from the first value of the first voltage and decreases gradually to zero at an edge of the fabrication object, and the second voltage decreases linearly.

In controlling the voltage distribution, another embodiment of the voltage distribution has a concave shape on an X-Y axes coordinate plane with the X-axis coordinate representing the diameter of the plasma chamber and the Y-axis coordinate being a voltage.

In controlling the voltage distribution, yet another embodiment of the voltage distribution has a convex shape on an X-Y axes coordinate plane with the X-axis coordinate representing the diameter of the plasma chamber and the Y-axis coordinate being a voltage.

In controlling the voltage distribution, yet another embodiment of the voltage distribution comprises a first value of a first voltage applied to a fabrication object at its central area in the plasma chamber and a second varying voltage applied to an edge of the central area as it starts from the first value of the first voltage and decreases nonlinearly gradually to zero at an edge of the plasma chamber.

Additionally, in controlling the voltage distribution, the first voltage is controlled through a modification of a bushing on the plasma chamber.

Also, in controlling the voltage distribution, the voltage distribution is controlled through design modifications of a plasma source of the plasma chamber such as modifications in number and/or thickness of source coils on the plasma chamber, forming the source coils in tubular shapes and spiral grooves provided on exterior surfaces of the source coils.

### ADVANTAGEOUS EFFECTS

As described above, the present method advantageously controls the critical dimension as desired and obtain the etching rate uniformity through the control of the plasma density distribution in the plasma chamber.

### DESCRIPTION OF DRAWINGS

FIG. 1 is a schematic sectional view of a plasma chamber including a conventional ACP source;

FIG. 2 is a plan view of the ACP source of FIG. 1;

FIG. 3 is a graph illustrating an ordinary voltage control;

FIG. 4 is a graph showing a first embodiment of a voltage distribution control for controlling the plasma density distribution in a plasma chamber according to the present disclosure;

FIG. 5 is a graph showing a second embodiment of a voltage distribution control for controlling the plasma density distribution in a plasma chamber according to the present disclosure;

FIGS. 6 and 7 graphically show third and fourth embodiments of a voltage distribution control for controlling the plasma density distribution in a plasma chamber according to the present disclosure;

FIG. 8 is a graph showing a fifth embodiment of a voltage distribution control for controlling the plasma density distribution in a plasma chamber according to the present disclosure;

FIGS. 9 and 10 graphically show sixth and seventh embodiments of a voltage distribution control for controlling the plasma density distribution in a plasma chamber according to the present disclosure;

FIGS. 11a to 11i show modifications of the bushing design to provide different voltage distributions in the premises of the bushings according to the present disclosure; and

FIGS. 12 to 14 illustrate design changes of the source coils according to the present disclosure.

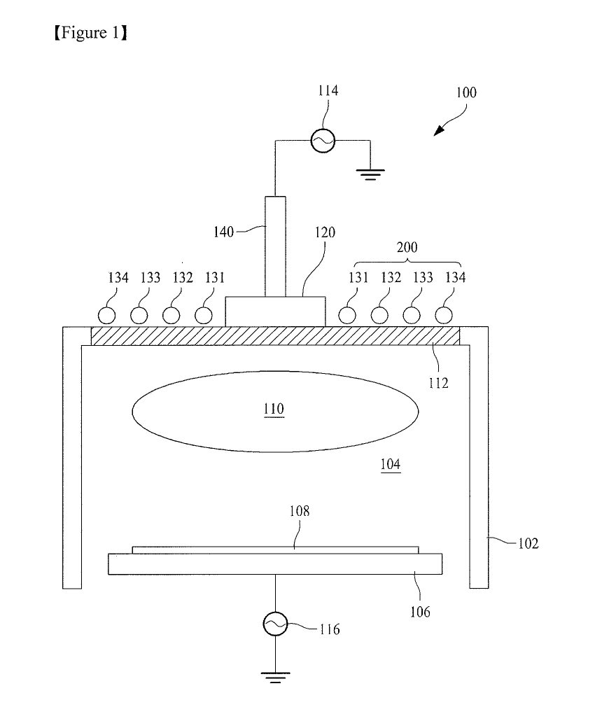

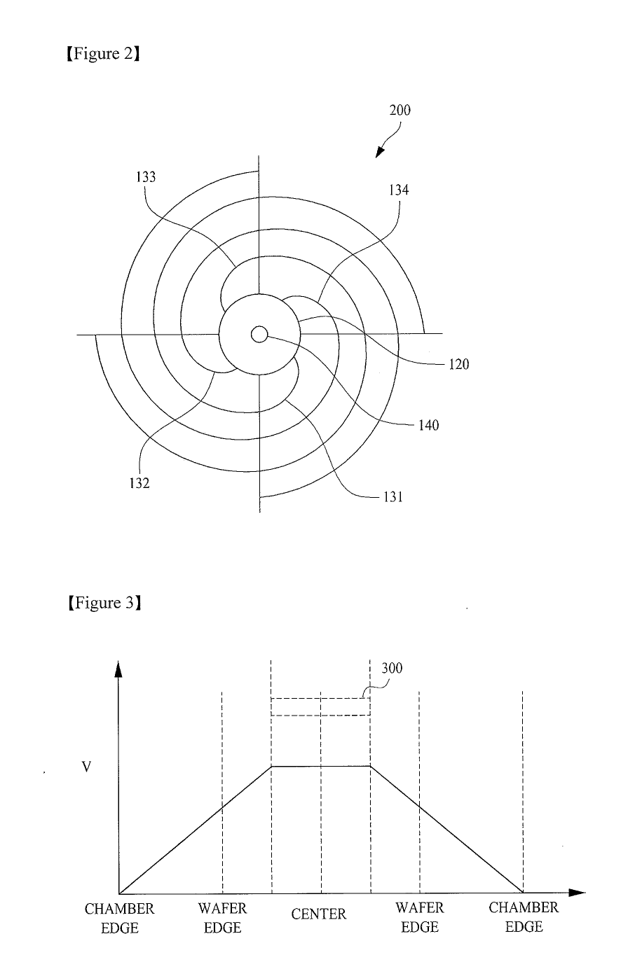

### MODE FOR INVENTION

Hereinafter, exemplary embodiments of the present disclosure will be described with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present invention rather unclear.

In the graph of FIG. 3 showing a typical voltage control on an X-Y axes coordinates plane with the X-axis coordinate representing the diameter of plasma chamber 100 and the Y-axis coordinate representing the voltage applied, a voltage distribution is formed of a first value of a first voltage applied to a central area to position the bushing 120 and a second voltage, which starts from the first voltage at an edge of the central area and decreases linearly gradually to zero at an edge of the plasma chamber 100.

Generally, the ACP source has two components of a coil and a bushing and its absolute voltage may be illustrated as in FIG. 3 where it is at the peak in the central area inclusive of the bushing 300 and becomes zero at ground. This voltage, which depends on the length of coil 200, determines the electric field strength that determines the intensity of magnetic field directly influencing the induced magnetic flux. This magnetic flux induced may determine the plasma density.

The critical dimension or CD may be determined by the intensity of electro-magnetic field, the chemical nature and amount of the gas used and the temperature and the pressure applied. The voltage distribution may be an important design parameter in determining CD which means CD may be changed by appropriately controlling the voltage distribution. It has been the conventional practice to change the CD with process parameters of temperature, pressure, gas, etc. and by using hardware.

The method for controlling plasma density distribution of the present disclosure is directed to controlling the CD with no involvements of the process parameters and hardware to change. This method may be applied to both the ICP source and the ACP source through an appropriate source design to control the CD and the etching rate.

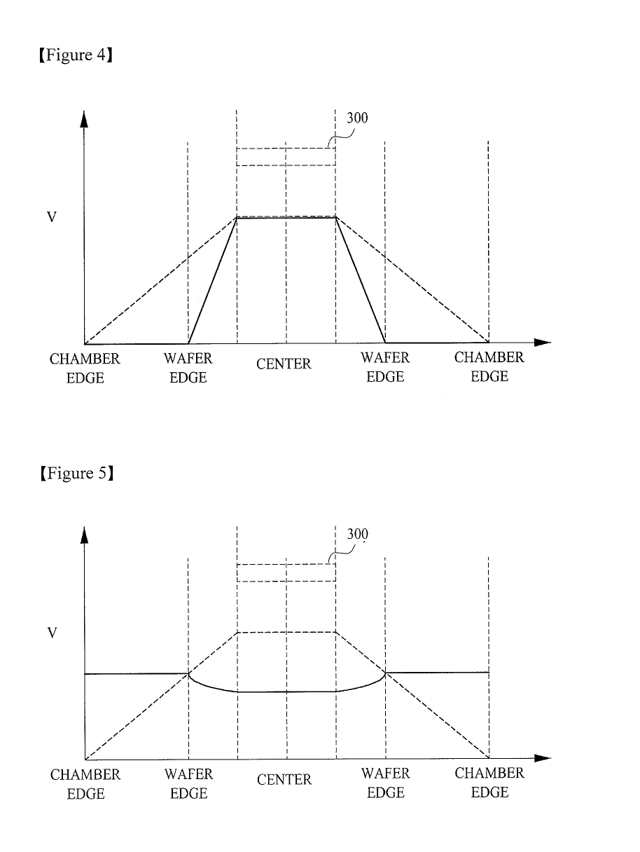

In the graph of FIG. 4 showing a first embodiment of a voltage distribution control for controlling the plasma density distribution in plasma chamber 100 according to the present disclosure, the X-axis coordinate represents the diameter of plasma chamber 100 and the Y-axis coordinate is the voltage applied.

In the first embodiment of the present disclosure illustrated, a voltage distribution is controlled so that a central area of a fabrication object (hereinafter referred to as wafer) encompassing the bushing 300 within the plasma chamber 100 receives a first value of a first voltage and a second varying voltage is applied to an edge of the central area as it starts from the first value of the first voltage and decreases linearly gradually to zero at an edge of the wafer.

This first embodiment of the voltage distribution control establishes the ground extending from the edge of the wafer to the edge of the plasma chamber. The voltage distribution of the first embodiment can reduce a profile tilting at the edge of the wafer since it precludes incoming of an external electric field distribution. Thus, the voltage distribution of the first embodiment may result in plasma density distribution changes, which in turn influence the CD and the etching rate.

In the graph of FIG. 5 showing a second embodiment of a voltage distribution control for controlling the plasma density distribution in plasma chamber 100 according to the present disclosure, the X-Y coordinates show a voltage distribution in a concave shape with the X-axis coordinate representing the diameter of plasma chamber 100 and the Y-axis coordinate being the voltage applied.

Conventionally, existing plasma density takes a convex shape, which is not desirable in terms of etching uniformity due to an inefficient diffusion by the wafer in fabrication at its center. The plasma density distribution does not completely depend on the voltage distribution. Whether the plasma density is shaped convex or concave will depend on the chamber design and the source design.

The concave voltage distribution as in the second embodiment of FIG. 5 is more advantageous in the aspect of etching uniformity thanks to more efficient diffusions by the wafer itself at its center. The CD distribution may be affected by other irregular electric field distributions. The concave plasma density distribution by the corresponding voltage distribution as in the second embodiment will be highly advantageous to provide a uniform etching. However, following the processing requirements a convex plasma density distribution may be desired.

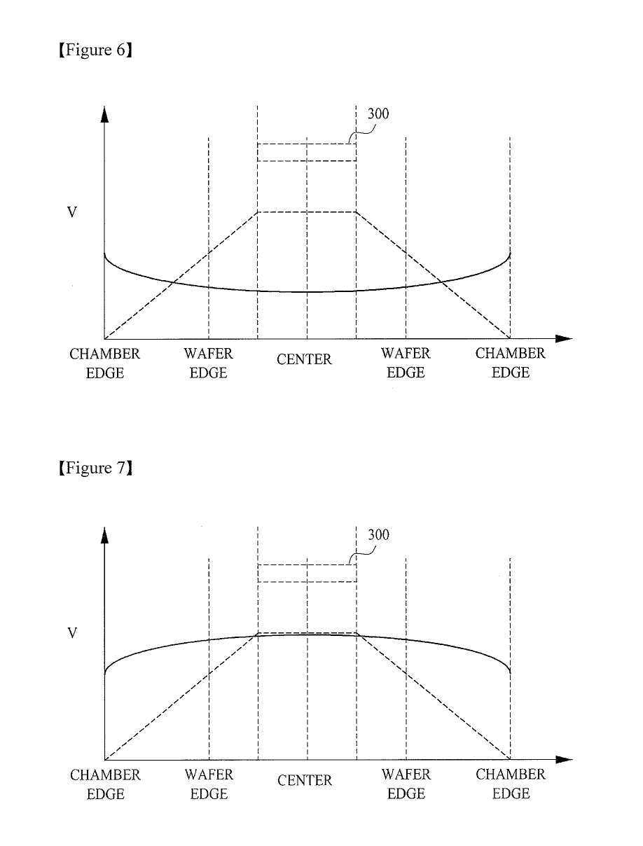

In the graph of FIG. 6 showing a third embodiment of a voltage distribution control for controlling the plasma density distribution in plasma chamber 100 according to the present disclosure, the X-Y coordinates show a voltage distribution in a concave shape with the X-axis coordinate representing the diameter of plasma chamber 100 and the Y-axis coordinate being the voltage applied.

The voltage distribution as in the third embodiment of FIG. 6 provides a uniform CD distribution due to the little changes of voltage in radial directions. The concave voltage distribution as in the third embodiment is highly advantageous in providing a uniform etching. However, following the processing requirements a fourth embodiment of a convex plasma density distribution as in FIG. 7 may be also desired.

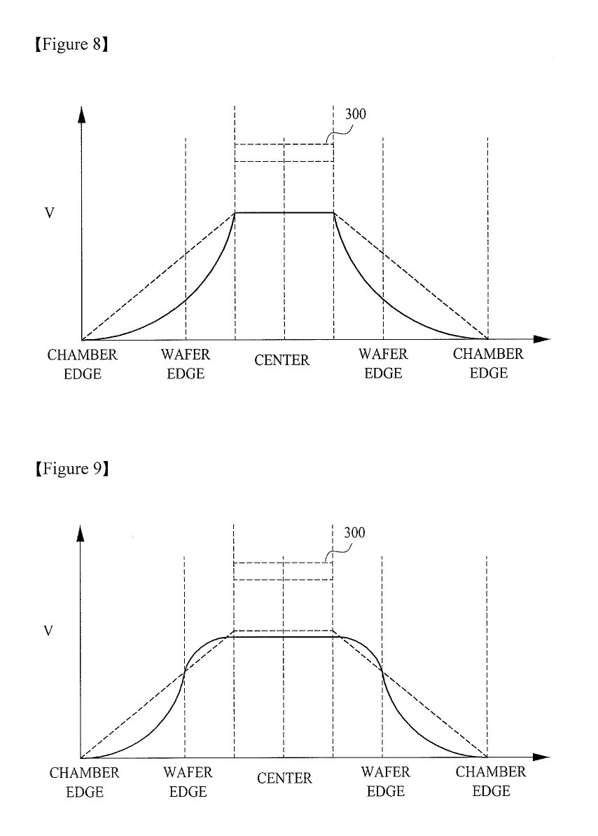

FIG. 8 is a graph showing a fifth embodiment of a voltage distribution control for controlling the plasma density distribution in the plasma chamber 100 according to the present disclosure wherein a voltage distribution is controlled so that the central area of the wafer 108 inclusive of the bushing 300 within the plasma chamber 100 receives a first value of a first voltage and a second varying voltage is applied to an edge of the central area as it starts from the first value of the first voltage and decreases nonlinearly gradually to zero at an edge of the plasma chamber 100.

The voltage distribution as in the fifth embodiment of FIG. 8 will improve the uniformity of CD and etching and can reduce a profile tilting at the edge of the wafer. In addition to the voltage distribution of the fifth embodiment, the source design and the corresponding chamber design when combined may improve the performance of the chamber process. Of course, the bushing formation (diameter, thickness, various shapes, material and so on) may become a factor in influencing the process performance.

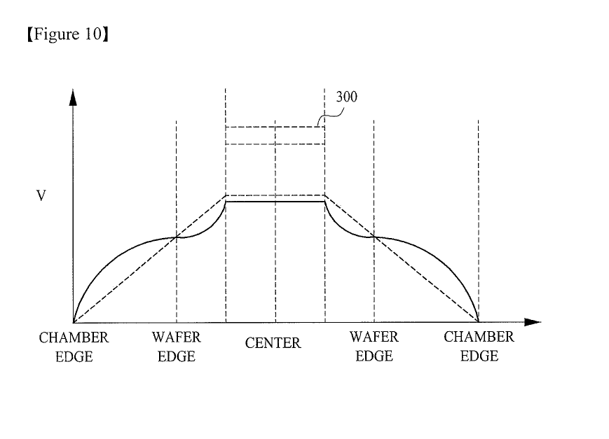

The voltage distributions of the sixth and seventh embodiments of FIGS. 9 and 10 will improve the uniformity of the CD and the uniformity of the etching rate resulting in corresponding changes in the plasma density distributions. In the sixth and seventh embodiments, the voltage distributions and chamber designing when combined will determine the resultant plasma density distributions. The voltage distribution of either the sixth embodiment in FIG. 9 or the seventh embodiment in FIG. 10 may be chosen as required in accordance with a specific process.

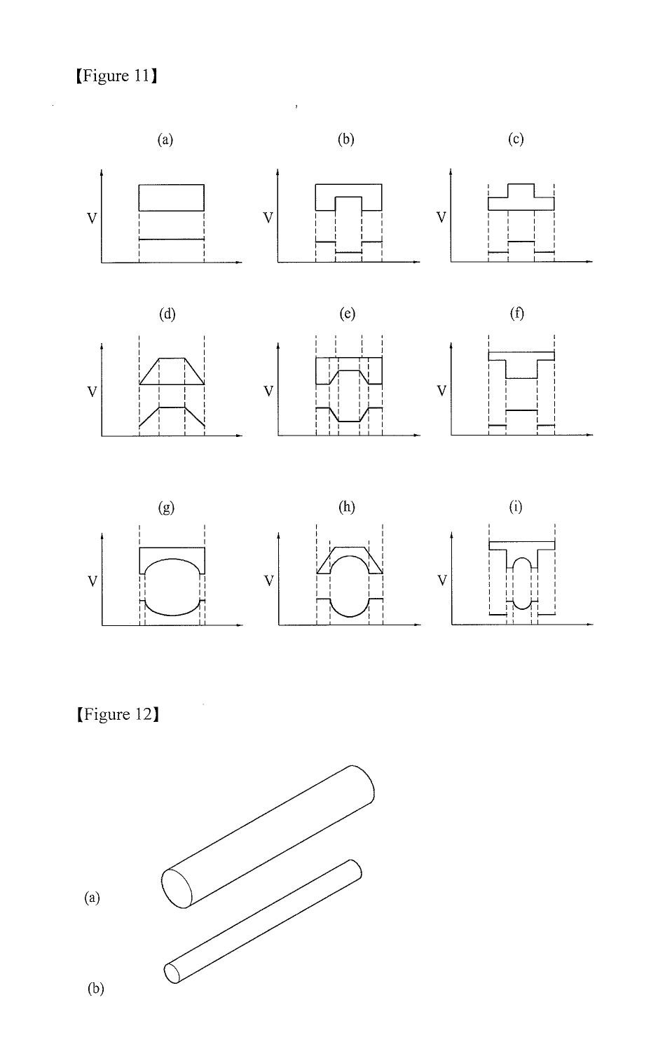

FIGS. 11a to 11i show modifications of the bushing design to provide different voltage distributions in the premises of the bushings according to the present disclosure. The ACP source may obtain various plasma density distributions through an appropriate choice of bushings, voltage distributions and chamber designs. Therefore, according to the present disclosure, the voltage distribution within the premises of the bushing may be changed with the various modifications of the bushing designs as illustrated in FIGS. 11a to 11i.

As illustrated in FIGS. 11a-11i, the bushing design changes will modify the voltage distribution within the bushing which changes the plasma density distribution, which in turn may influence the uniformity of etching rate and the uniform CD.

A single plasma line source design may present a high impedance, a low current flux and a low plasma density distribution. In comparison, branched plural line source designs may show a low impedance, a high current flux and a high plasma density distribution. The final plasma density distribution will be determined by the source design and the chamber design. Thus, the singular or plural line source designs will permit various configurations of voltage distribution to be designed.

FIGS. 12 to 14 illustrate design changes of the source coils according to the present disclosure.

FIG. 12 at (a) shows a general coil structure and at (b) shows a similar coil with an even smaller diameter. Reducing the coil diameter as at (b) will increase the electric resistance due to the reduced surface area. Thus, compared to the coil at (a) the coil at (b) may limit the electric current well to present a weaker induced magnetic field and thus lowered plasma density.

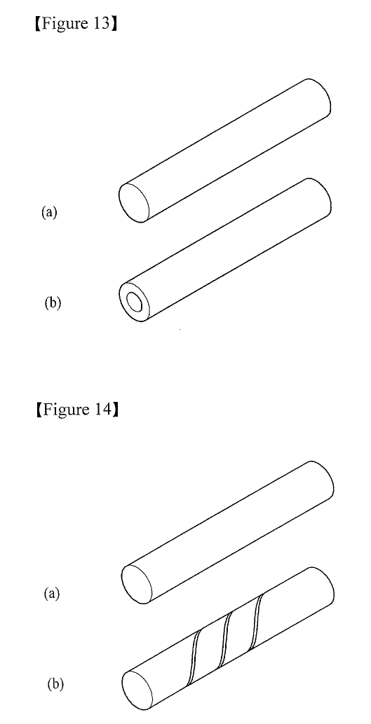

FIG. 13 at (a) shows a general coil structure and at (b) shows a tubular coil with a hollow core. Since RF electric current flows along the surfaces of the coil, the tubular coil at (b) is advantageous over the plain coil at (a). Thus, in a high power application the coil at (b) may accommodate coolant inside.

FIG. 14 at (a) shows a general coil structure and at (b) shows a similar coil with helical grooves. The surface area of the coil at (b) is larger than that of the same diameter of coil at (b). Further, the coil of FIG. 13 at (b) and the coil of FIG. 14 at (b) combined may be used effectively when compared to the other shapes described above.

As described above, the coil voltage control technology for the ICP source and the ACP source of the present disclosure was inspired by using electrical thoughts. When combined with the chamber designing the voltage control according to the present disclosure influences the plasma density and thus the process performances such as the etching rate uniformity and the CD uniformity. Also, the various bushing designs were developed to control the coil voltage distributions which will have a direct influence through the plasma density distribution on the process performance. In addition, the plasma density influencing the process performances may be modified through various source branches which is conceptually grounded on electrical connections. Furthermore, a cross section of the source coil may have an important role in determining the plasma density distribution and eventually influence the process performances.

Although exemplary embodiments of the present disclosure have been described for illustrative purposes, those skilled in the art will appreciate that various modifications, additions and substitutions are possible, without departing from the characteristic features of the present disclosure. Therefore, the embodiments disclosed in the present invention have been described not for limiting the scope of the disclosure and accordingly, the scope of the disclosure is not to be limited by the above embodiments but by the claims and the equivalents thereof. It will be understood by those skilled in the art that various changes in form and details may be made without departing from the claimed scope of the disclosure.

### INDUSTRIAL APPLICABILITY

As described above, the present disclosure has a high usability in semiconductor fabrication methods to control the critical dimension and obtain the etching rate uniformity through the control of the plasma density distribution in the plasma chamber.

### CROSS-REFERENCE TO RELATED APPLICATION

This non-provisional application claims priorities under 35 U.S.C §119(a) on Patent Application No. 10-2007-0141335 filed in Korea on Dec. 31, 2007, the entire contents of which are hereby incorporated by reference. In addition, this non-provisional application claims priorities in countries, other than U.S., with the same reason based on the Korean Patent Application, the entire contents of which are hereby incorporated by reference.

1. A method for controlling plasma density distribution in a plasma chamber used to fabricate a semiconductor device comprising:
establishing an intended plasma density distribution in the plasma chamber; and
controlling a voltage distribution in the plasma chamber with relation to the established plasma density distribution.

2. The method for controlling plasma density distribution in a plasma chamber in claim 1, wherein voltage distribution in the controlling of the voltage distribution comprises a first value of a first voltage applied to a fabrication object at its central area in the plasma chamber and a second varying voltage applied to an edge of the central area as it starts from the first value of the first voltage and decreases gradually to zero at an edge of the fabrication object.

3. The method for controlling plasma density distribution in a plasma chamber in claim 2, wherein the second voltage decreases linearly.

4. The method for controlling plasma density distribution in a plasma chamber in claim 1, wherein voltage distribution in the controlling of the voltage distribution has a concave shape on an X-Y axes coordinate plane with the X-axis coordinate representing the diameter of the plasma chamber and the Y-axis coordinate being a voltage.

5. The method for controlling plasma density distribution in a plasma chamber in claim 1, wherein voltage distribution in the controlling of the voltage distribution has a convex shape on an X-Y axes coordinate plane with the X-axis coordinate representing the diameter of the plasma chamber and the Y-axis coordinate being a voltage.

6. The method for controlling plasma density distribution in a plasma chamber in claim 1, wherein voltage distribution in the controlling of the voltage distribution comprises a first value of a first voltage applied to a fabrication object at its central area in the plasma chamber and a second varying voltage applied to an edge of the central area as it starts from the first value of the first voltage and decreases nonlinearly gradually to zero at an edge of the plasma chamber.

7. The method for controlling plasma density distribution in a plasma chamber in claim 1, wherein the controlling of the voltage distribution controls the first voltage through a modification of a bushing on the plasma chamber.

8. The method for controlling plasma density distribution in a plasma chamber in claim 7, wherein the bushing is modified in its cross section.

9. The method for controlling plasma density distribution in a plasma chamber in claim 1, wherein the controlling of the voltage distribution controls the same through a design modification of a plasma source of the plasma chamber.

10. The method for controlling plasma density distribution in a plasma chamber in claim 1, wherein the controlling of the voltage distribution controls the same through a modification in number of source coils on the plasma chamber.

11. The method for controlling plasma density distribution in a plasma chamber in claim 1, wherein the controlling of the voltage distribution controls the same through a modification in thickness of source coils on the plasma chamber.

12. The method for controlling plasma density distribution in a plasma chamber in claim 1, wherein the controlling of the voltage distribution controls the same through forming source coils on the plasma chamber in tubular shapes.

13. The method for controlling plasma density distribution in a plasma chamber in claim 1, wherein the controlling of the voltage distribution controls the same through spiral grooves provided on exterior surfaces of source coils on the plasma chamber.
